(19) United States
(12) Patent Application Publication
(10) Pub. No.: US 2025/0272716 A1
(43) Pub. Date: Aug. 28, 2025

(54) CONNECTED TV OUT-OF-HOME CONTEXTUALIZED ADVERTISING

(71) Applicant: Atmosphere.tv, Austin, TX (US)

(72) Inventors: Brent Hays, Austin, TX (US); Michael Angstadt, Pflugerville, TX (US); Michael W. Santa Cruz, Boise, ID (US)

(21) Appl. No.: 18/588,396

(22) Filed: Feb. 27, 2024

(51) Int. Cl. G06Q 30/0251; H04N 21/234; H04N 21/442; H04N 21/81

(52) U.S. Cl. CPC G06Q 30/0261; H04N 21/23424; H04N 21/44213; H04N 21/812

(57) ABSTRACT

Systems and methods are disclosed for implementing connected TV (CTV) out-of-home (OOH) contextualized advertising. In certain embodiments, a method may comprise implementing a system to negotiate OOH advertising based on a proximate user device, including receiving, at a content streaming service, an identifier of a user device and location information indicating a location of the user device, the user device including a portable computing device. The method may further comprise negotiating, via the content streaming service, an advertisement to display at an OOH advertising screen proximate to the location of the user device based on the identifier, and displaying the advertisement at the OOH advertising screen.

### SUMMARY

In certain embodiments, a method may comprise implementing a system to negotiate out-of-home (OOH) advertising based on a proximate user device, including receiving, at a content streaming service, an identifier of a user device and location information indicating a location of the user device, the user device including a portable computing device. The method may further comprise negotiating, via the content streaming service, an advertisement to display at an OOH advertising screen proximate to the location of the user device based on the identifier, and displaying the advertisement at the OOH advertising screen.

In certain embodiments, a system may comprise a content streaming service configured to negotiate out-of-home (OOH) advertising based on a user device proximate to an OOH advertising screen. The system may receive an identifier of the user device and location information indicating a location of the user device, the user device including a portable computing device, negotiate an advertisement to display at an OOH advertising screen proximate to the location of the user device based on the identifier, and display the advertisement at the OOH advertising screen.

In certain embodiments, a memory device may store instructions that, when executed, cause a processor to perform a method comprising implementing, via a content streaming service, a system to negotiate out-of-home (OOH) advertising based on a proximate user device, including receiving a mobile advertising identifier (MAID) of a user device and location information indicating a location of the user device, the user device including a portable computing device. The instructions may cause the processor to perform the method further comprising negotiating an advertisement to display at an OOH advertising screen proximate to the location of the user device based on the MAID, and displaying the advertisement at the OOH advertising screen.

### BRIEF DESCRIPTION OF THE DRAWINGS

FIG. 1 is a diagram of a system configured to implement connected TV (CTV) out-of-home (OOH) contextualized advertising, in accordance with certain embodiments of the present disclosure;

FIG. 2 depicts a process flow of an example method for implementing CTV OOH contextualized advertising, in accordance with certain embodiments of the present disclosure;

FIG. 3 depicts a flowchart of an example method for implementing CTV OOH contextualized advertising, in accordance with certain embodiments of the present disclosure; and

FIG. 4 is a diagram of a system configured to implement CTV OOH contextualized advertising, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

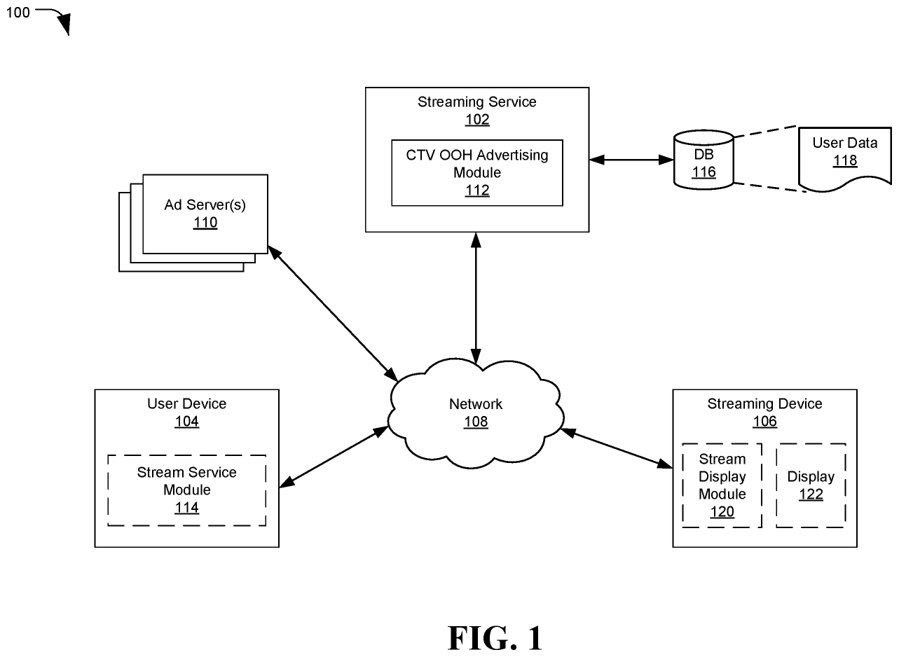

FIG. 1 depicts a diagram of a system 100 configured to implement connected television (CTV) out-of-home (OOH) contextualized advertising, in accordance with certain embodiments of the present disclosure. In particular, FIG. 1 depicts an example streaming system 100 that is configured to provide a more customized, personalized, or otherwise contextually relevant selection of advertisements at a CTV OOH streaming device than has been previously available. OOH advertising may refer to advertising experienced outside the home, including place-based media, that may be presented as billboards, posters, advertising screens, and other media encountered at brick-and-mortar venues or otherwise “on the go”. CTV refers to devices connected to the internet that allow the streaming of videos, music, and similar media. Accordingly, CTV OOH advertising may include advertising shown on network-connected televisions, billboards, kiosks, point of sale (POS) systems, or other screens situated outside the home in public locations and venues.

The streaming system 100 may include a streaming service 102, a user device 104, a streaming device 106, an ad server 110, and a network 108. Each or any of streaming service 102, user device 104, streaming device 106, ad server 110, and network 108 may be implemented via computers, servers, hardware and software modules, or other system components. Further, streaming service 102 may include or have access to a database (DB) or storage system 116. DB 116 may include one or more data storage devices, data storage mediums, data storage servers, and related data structures, and may store information about streaming service 102, user device 104, streaming device 106, ad server 110, user data 118, or other information.

Streaming service 102, sometimes referred to as content display service, may generate, publish, display, or broadcast content to streaming device 106. Some or all of the content, such as video segments or advertisements, may originate from the streaming service 102 itself, or may be obtained or transmitted from one or more other content sources, such as ad server 110. For example, streaming service 102 may stream content such as news, sporting events, videos, or other content, with breaks for advertising segments. In other examples, streaming service 102 may display a sequence of advertisements without other content elements.

Streaming service 102 may include actionable content into the streamed content, such as scannable indicators include quick response (QR) codes, or web addresses or links that viewers of the stream can engage with. The actionable content may be customized based on a target streaming device 106 or associated venue or location, so that users interacting with the actionable content may provide the streaming service 102 with an indication of which streaming device 106 the user is viewing or at which venue the user is located. In some examples, the streaming service 102 may have or host an associated mobile application, web application, or other application with which users may interact.

Streaming device 106 may comprise a CTV OOH device such as a television, monitor, electronic billboard, set top box, or other device that streams content for display, such as over the top (OTT) media streamed via network 108 (e.g., the internet) from streaming service 102, ad server 110, or another source. In some examples, streaming devices 106 may include Android TV® or tvOS® streaming televisions. Streaming device 106 may be situated in a public venue, such as a bar, restaurant, club, shopping center, park, or other OOH location. Streaming device 106 may include a stream display module 120 and a display 122.

Stream display module 120 for streaming device 106 may perform operations associated with receiving streamed content and displaying it via display 122. For example, stream display module 120 establish a connection with streaming service 102 or other stream content provider, including tuning between available streaming channels. The stream display module 120 may provide streaming service with a device identifier for streaming device 106, security keys, data identifying a location or venue for streaming device 106, or other data that streaming service 102 may use to identify the streaming device 106 and it's associated location or venue. Streaming display module 120 may receive one or more stream files from streaming service 102 or other content provider, which stream files the stream display module may decompress, decode, convert, or otherwise read and prepare the stream content for display. In some examples, the stream display module 120 may receive all stream content from a single source (e.g., streaming service 102). In other examples, stream display module 120 may obtain or receive content from multiple sources. For example, stream display module 120 may receive a content stream from streaming service 102, along with indications of where or when ad breaks are situated in the streaming content. For the ad breaks, the stream display module 120 may receive advertisements to display from one or more ad servers 110. The streaming display module may also combine multiple data elements into a single display stream. For example, stream display module 120 may combine a stream of video content along with data for a news ticker, sports score ticker, stock ticker, weather updates, “coming next” previews, or other information for a bottom bar or an L-bar to frame the video stream.

Display 122 may include a combination of physical display components such as a television screen or monitor, and graphical elements such as streaming video, overlays such as news tickers, informational or decorative border elements, QR or other scannable overlays or additions, graphical or animation additions, or other visual or audio elements. In some embodiments, display 122 may be configured to receive user inputs, such as touch screen controls, remote control signals, or other inputs for streaming device 106. The display 122 may work in conjunction with stream display module 120 to display content streams and advertising content.

User device 104 may comprise a network 108—connected portable computing device carried on a user's person when OOH. For example, user device 104 may include a smart phone, tablet, laptop device, or other computing device that a user may bring to a venue such as a restaurant, coffee shop, park, or other public location where CTV OOH streaming devices 106 may display advertising. User device 104 may include a user interface including user input elements (e.g., touch screen, keyboard, pointer device, or other physical input components), as well as a graphical user interface (GUI). User device 104 may include components and features such as global positioning system (GPS) sensors, Bluetooth communication, camera elements, mobile connectivity, wireless fidelity (Wi-Fi) connectivity, or other features usable to connect to or interact with actionable content, exchange data, and track and share location information. For example, user devices 104 may include a camera element and software configured to scan a QR code displayed on streaming device 106, and obtain data from it such as a web address. The QR code may direct the user device 104 to open a mobile app for streaming service 102, or may enable the user device 104 to follow a link using a web browser app to access a web app for streaming service 102. Utilizing the actionable content (such as a custom QR code) may cause the user device 104 to provide the streaming service 102 with an indication of where the actionable content was viewed, such as via metadata embedded in the actionable content. In another example, user device 104 may share location information with streaming service 102 via other means, such as via GPS information shared via a mobile app or web app, or Bluetooth or Wi-Fi connection at a location or venue of the streaming device 106. User device 104 may include a stream service module 114 for interacting with streaming service 102.

Stream service module 114 may include an app or other program including executable instructions for interacting with streaming service 102. For example, stream service module 114 may include a mobile application loaded and executed on user device 104, or a web application hosted online, and accessed by user device 104 via network 108. Streaming service 102 may provide the application as a way for users to upload content, participate in games, check in or share a user's location at a venue, to receive offers or promotions to venues, select content for streaming to streaming device 106, or to perform other operations. The stream service module 114 may share a venue or location information for where the user device 104 is located, such as based on GPS data, Bluetooth or Wi-Fi connection, or by sharing metadata from actionable content displayed at streaming device 106. Stream service module 114 may also share other data or information about user device 104 with streaming service 102, such as a device identifier.

Streaming service 102 may negotiate advertising to display at streaming device 106 with ad server 110, for example via real time bidding (RTB). The streaming service 102 may provide information about the available advertising slots, and advertisers may bid on the advertising slots based on the information. There may be multiple ad servers 110 involved in the advertising negotiating process, such as an ad exchange or server-side platform (SSP), a demand-side platform (DSP), one or more advertisers, and potentially storage servers where the advertisements themselves may be stored and transmitted for display (e.g., either to streaming service 102 or streaming device 106). SSPs may represent advertising publishers in the bidding process, including receiving information on an ad publisher's ad inventory (e.g., available ad slots), and providing that information to a DSP. A DSP may represent advertisers in the bidding, by sharing the ad inventory details and receiving bids for the ad inventory from advertisers. The highest presented bid for an ad slot (e.g., represented as CPM, cost per mille) may win the right to advertise in the slot.

The information provided to advertisers may include a number and duration of advertising slots, time period, a target customer or device identifier, or other information. An example identifier may include a mobile advertising identifier (MAID). A MAID may include a unique identifier tied to a particular device, such as CTV devices or personal mobile devices. In turn MAIDs may be associated with users that own or use the device, including demographic information (gender, age, etc.), interests, shopping habits, or other details that may be relevant to advertisers. MAID information may be fully or pseudo-anonymous to protect the identity or personally identifying information (PII) of an associated user, and instead may only be associated with an anonymous profile of demographics and interests. In the case of a CTV OOH streaming device 106, the MAID may be associated with a type of venue, location, and similar information.

In an example embodiment, streaming service 102, streaming device 106, or another component of streaming system 100 may conduct an RTB bidding process for an ad inventory of advertising slots in a content stream displayed at streaming device 106. Streaming service 102 may provide a MAID for streaming device 106 to one or more ad exchange or SSP ad servers 110. The SSP may provide the MAID and associated metadata information for the ad inventory to one or more DSPs, through which advertising bids are received. However, the MAID for a CTV OOH streaming device 106 may have limited associated metadata, such as location and type of venue. Advertisers may not know whether there are any patrons in a venue, or any particular interests or demographics of potential patrons. This may result in low-value bids, or even unused advertising inventory for the streaming service 102.

To address this limitation, streaming service 102 may include a CTV OOH advertising module 112. Advertising module 112 may be configured to obtain identifier information for user device 104 based on the user device's proximity to streaming device 106. As an example, when user device 104 interacts with actionable content displayed on streaming device 106, the user device 104 may provide (e.g., via stream service module 114) to streaming service 102 metadata or other information indicating what streaming device 106 the content was viewed from, along with a MAID or other identifier for the user device 104. In this manner, the streaming service 102 may know that the streaming device 106 is being viewed by a user of user device 104, and that the user is located in the corresponding venue. In another example, stream service module 114 may provide identifier data and location information, such as GPS data or an affirmative “check in” by a user to a venue, to streaming service 102. Streaming service 102 may use the location information to determine whether the user is in the same venue as streaming device 106. Types of identifiers for a user device that may be provided include a MAID, a phone number, a device serial number, an identifier for advertisers (IDFA), IP address, Ramp ID, or other unique personal or device identifiers. For ease of description, reference may be made herein to identifiers or MAIDs, although other types of identifiers are included within the intended scope of this disclosure.

Advertising module 112 may store the MAID information for user device 104, and potentially associated location information, to user data 118. The advertising module 112 may also store information such as which actionable content the user interacted with. In this manner, the streaming service 102 may develop user profiles in user data 118, showing whether particular users repeatedly frequent a same venue, express interest in a type of content or advertisements, or similar information.

When streaming service 102 engages in advertising negotiations for ad inventory, rather than providing a MAID of the streaming device 106, the advertising module 112 may instead provide one or more MAIDs of user devices 104 located in the venue or location of streaming device 106, where the advertisements will be shown. Advertising module 112 may provide additional information, such as user profile 118 information, along with the user device 104 MAID. Further user habits or interests may be associated with the MAID at ad servers 110 based on other data sources. A user device 104 MAID, based on the greater available metadata for an associated user, may provide a more appealing bidding opportunity for advertisers than a CTV OOH streaming device 106 alone. Advertising module 112 may store a record of the winning bid(s) for the provided MAID, for example in user data 118.

In some embodiments, the advertising bidding platforms may only accept a single MAID for a round of bidding. If there is more than one valid user device 104 MAID for the appropriate venue, the streaming service 102 may select a MAID at random, or round-robin style. Over time, advertising module 112 may build a more robust history of bid values for various MAIDs. Accordingly, advertising module 112 may select a specific MAID that has a history of receiving the consistent high bid values.

In some examples, streaming service 102 may receive updates from user device 104 based on location, purchases, or other information. This information may further supplement user profiles in user data 118, and can make associated MAIDs more valuable to advertisers.

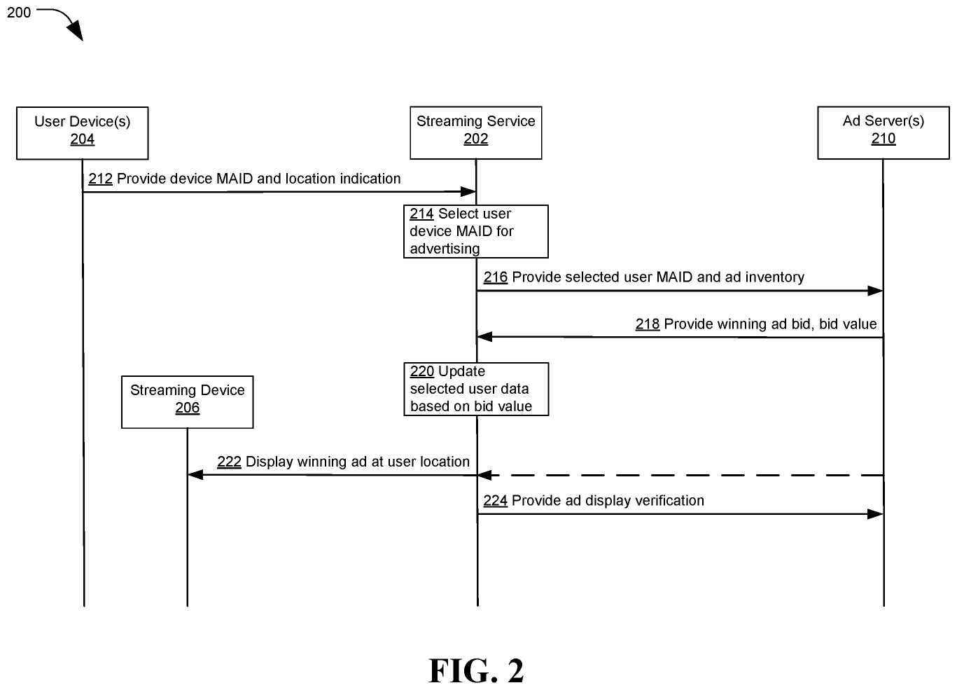

According to the proposed embodiment, streaming device 106 may be used to deliver a more customized or contextually relevant set of advertising and content, that may be selected based on actual viewer preferences or interests. Advertisers may obtain higher value from advertising bids by knowing the advertising is reaching viewers that may share a targeted set of interests. In some examples, users may be encouraged to participate in the program based receiving advertisements or offers relevant or valuable to them. For example, advertisements may include coupons or offers that users can take advantage of (e.g., by scanning a QR code to add a coupon to their user device 104), and by receiving advertisements relevant to their interests, users are more likely to obtain value from the advertising. A process flow for implementing a CTV OOH contextualized advertising system is described in regard to FIG. 2

FIG. 2 depicts a diagram of a system 200 configured implement CTV OOH contextualized advertising, in accordance with certain embodiments of the present disclosure. In particular, FIG. 2 presents an operational flow of an example embodiment of a content streaming system configured to negotiate and display contextualized advertisements based on the MAIDs of a user device 204 situated within proximity of streaming device 206. System 200 may include a streaming service 202, a user device 204, a streaming device 206, and an ad server 210, which may correspond to streaming service 102, user device 104, streaming device 106, and ad server 110 of FIG. 1. The components of system 200 may communicate over one or more networks, such as network 108 of FIG. 1.

At 212, user device 204 may provide a device MAID and an indication of a location for the user device to streaming service 202. The MAID, or other identifier that may be used as part of an advertisement negotiation process, may be provided from user device 204 to streaming service 202 as part of a data transmission. The transmission may be made specifically to provide the MAID, or the MAID may be included as part of another transmission, such as a login process, following a link from a QR code or other actionable item, participating in a trivia game via an app associated with streaming service 202, or via other transmission. The location indication can be provided via information such as GPS data providing a direct indication of location, or via transmitting data embedded in a QR code or other actionable content displayed at a location, checking in at a location, or other indication that the user device 204 is at an identifiable venue or location.

At 214, the streaming service 202 may select a user device 204 MAID for negotiation of advertisements at a selected venue, based on the user device 204 location. If there are multiple user device 204 MAIDs available at a selected venue, the streaming service 202 may select which MAID to use randomly, or round-robin style (e.g., selecting user 1, then user 2, then user 3, then back to user 1, etc.). In some embodiments, the streaming service 202 may store records of bid values received for each user device 204 MAID, and may select which MAID to use based on which ones have received the highest bids historically. In some embodiments, streaming service 202 may provide multiple user device 204 MAIDs for advertisement bidding, and bids may be made based on the combination of the multiple MAIDs. A single MAID may be used for negotiating an entire ad break including multiple ad spots, or one MAID may be used for each individual ad slot. Based on using MAIDs for user device(s) 204 in a particular location or venue, advertisements may be negotiated independently for each streaming device 206 or venue.

At 216, based on the user device 204 MAID selection at 214, the streaming service 202 may provide the selected user MAID and an available ad inventory to ad server 210 for bidding. In some embodiments, the streaming service 202 may provide additional information, such as information about the demographics, interests, venue visits and location history, or other details for a user associated with the selected user device 204 MAID. Ad server 210 may comprise an ad exchange or SSP, DSP, for bidding, or one or more specific advertisers for direct ad negotiation. Based on the bidding or negotiation, the ad server 210 may provide the winning ad bid, along with the bid value, at 218. The winning ad bid may include the advertisement itself (e.g., a video file), or may include information by which the advertisement may be retrieved (e.g., a network address and credentials by which the ad file may be accessed by the streaming service 202 or the streaming device 206). The bid value may include a cost per mille (CPM) amount or some other bid metric.

At 220, the streaming service 202 may update the user data corresponding to the selected user device 204 MAID based on the bid value. The streaming service 202 may record the bid value or values received for the ad inventory based on the corresponding user device 204 MAID. The bid value may be used in future determinations of which user device 204 MAID to offer for future ad inventory negotiations. At 220 or another point, the streaming service 202 may store or update other details for the user data, such as a venue or location history, whether the user has interacted with advertisements shown (e.g., by interacting with actionable content included in advertisements), interests, or other details.

At 222, the ad(s) that won the bid(s) or negotiations at 218 may be displayed at the location of the user device corresponding to the selected MAID, via streaming device 206. The ad content may be retrieved by or provided to the streaming device from the streaming service 202 or from an ad server 210. In some examples, the streaming service 202 may add or modify actionable content to the displayed advertisements at streaming device 206, and may track or monitor user engagement with the displayed advertisements. In another example, an application on a user device 204 (e.g., stream service module 114) may monitor user engagement with a displayed advertisement, and may provide information about the user engagement to streaming service 202. The streaming service 202 or the streaming device 222 may monitor progress of any displayed ads, for example whether 25%, 50%, 75%, or 100% of the advertisement was displayed.

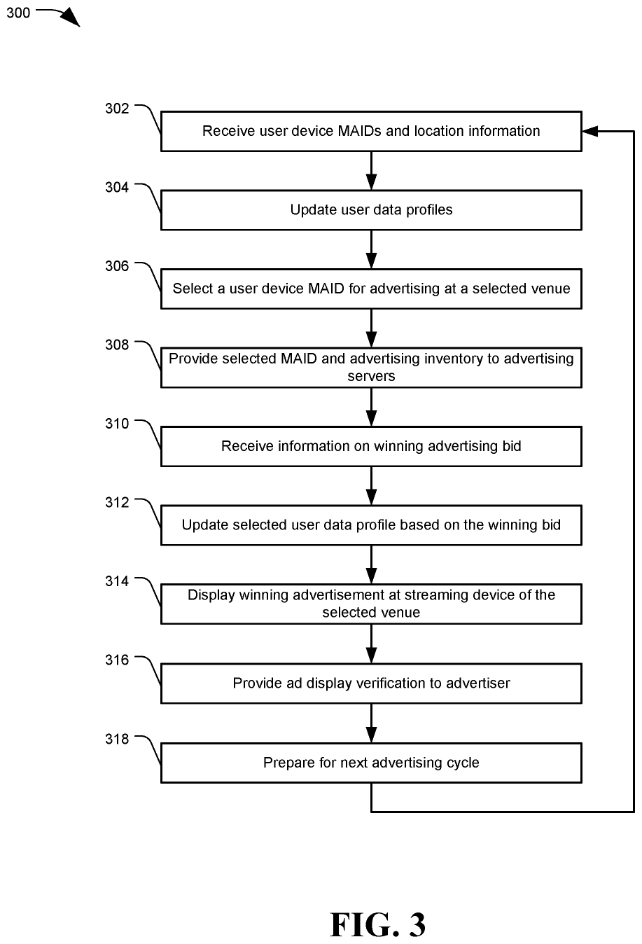

At 224, the streaming service 202 may provide ad display verification information to the ad server 210. For example, the verification information may include the progress of how much of the advertisement was displayed. Ad verification information may also include any user interaction or engagement with the advertisement that the streaming service 202 has information on. Streaming service 202 may also update user data or user profiles based on any user engagement with any displayed advertisements. FIG. 3 depicts an example method for performing CTV OOH contextualized advertising.

FIG. 3 depicts a flowchart 300 of an example method for implementing CTV OOH contextualized advertising, in accordance with certain embodiments of the present disclosure. In particular, the method of FIG. 3 may be a process for negotiating advertisements to play at an OOH streaming device based on a user device in a same venue or location as the streaming device. The method of FIG. 3 may be implemented by systems shown in FIG. 1, such as streaming service 102, user device 104, streaming device 106, ad server 110, or some combination thereof, generally collectively referred to as the streaming system 100.

At 302, the method may include receiving one or more user device mobile advertising identifiers (MAIDs) and location information. The location information, which may provide direct data on a user's location (e.g., via GPS coordinates from the user device) or indirect data (e.g., based on a user device scanning or using actionable content from a particular OOH advertising location), may provide a streaming service with information on when a user device is in a same venue or proximity to an OOH advertising location, such as a CTV OOH streaming device.

The method may include updating a user data profile corresponding to a received user device MAID and location information, at 304. For example, if this is the first time a particular user device (and it's corresponding MAID) have interacted with OOH advertising location, or used a web or mobile app to share location information, the method may include generating a new user profile to go with the received MAID. If a user profile already exists for the MAID or corresponding user, the profile may be updated with a log of their location and potentially date or time, how the location was logged (e.g., via the user using a web app or mobile app, via GPS coordinates, via scanning and following a link from a custom QR code for a particular OOH streaming device, etc.). If a user interacted with actionable content from a particular advertisement, the user profile may be updated to indicate the user has an interest in the advertisement's subject matter. Other data profile updates may also be made.

At 306, the method may include selecting a user device MAID for use in negotiating advertising at a selected venue. For example, if there is available ad inventory at an OOH streaming device at a particular venue, the method may include determining whether there are nearby user devices for which a MAID is available. The determination may be made based on checking user profiles for location information, or keeping a separate database or log of which user device MAIDs are at each OOH streaming device location for a period of time. Of any nearby user devices, a corresponding user device MAID may be selected for use in advertising negotiations. The user device may be selected randomly, or in a round-robin pattern, or based on a history of advertising bid values for the available MAIDs (e.g., which bid values may be stored in the user data profiles).

The selected MAID and the available advertisement inventory may be provided to one or more advertising servers, at 308. Additionally, metadata associated with the selected MAID, such as demographic details or interests for a corresponding user, may also be provided. The ad servers may be open advertising exchanges or bidding servers, or may be the direct servers of potential advertisers who may be interested in the available ad inventory slots. The advertisers may make bids or offers for the ad inventory based on the selected user device MAID and any available associated metadata. A highest bid offer may be accepted as the winning bid.

At 310, the method may include receiving information on the winning advertising bid. The information may include the value of the bid, the advertisement file or a link and credentials on where and how to retrieve the advertisement, an ad ID or promotional program identifier, or other details about the winning advertisement.

The method may include updating the user data profile of the selected user device MAID based on the winning bid, at 312. The user profile may be updated with the bid value, and potentially other information such as a date, time, and location of the bid, a type of advertisement, or other details. The user profile may be updated with a history of bid values, or the bid values may be averaged over time, or some other method may be used to determine an “advertising value” of a particular MAID.

At 314, the method may include displaying the winning advertisement at a streaming device of the selected venue. Playing a winning advertisement may include streaming an advertising file from a streaming service to the OOH streaming device. In another example, the streaming service may provide the network address and credentials for retrieving the advertisement to the streaming device, and the streaming device may retrieve and display the advertisement. Other implementations are also possible. The progress of a displayed advertisement may be tracked at the streaming device or the streaming service. In some examples, the advertisement may be displayed along with actionable content, and the streaming service may be capable of monitoring user engagement with the actionable content. For example, a QR code may be superimposed on or displayed along side the advertisement, which QR code may route a user device through a website monitored by the streaming service.

At 316, the method may include providing ad display verification to the advertiser. Ad display verification may include information of how much of the advertisement played successfully. In some examples, indications of user interaction or engagement with the advertisement may be provided as well, such as an indication that actionable content was viewed or scanned. In some embodiments, the streaming service may provide additional follow-up details, such as advertisement engagement based on user location information. For example, if an advertisement was for a local fast-food restaurant, and user device location information provided to the streaming service indicates that a user from the venue where the advertisement was displayed later traveled to the fast-food restaurant, this feedback may be provided to the advertiser to indicate that the advertisement was successful. Other implementations are also possible.

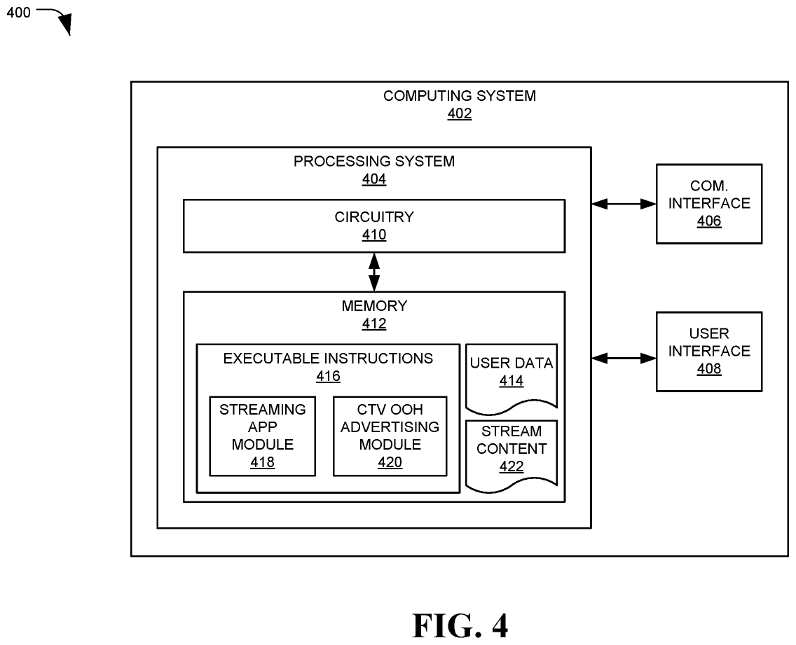

At 318, the method may include preparing for a next advertising cycle, such as a next ad break with a new ad inventory of available advertising slots. The method may return to receiving user device MAIDs and location information, and selecting a MAID to use in the advertising negotiations. An example system for implementing a CTV OOH contextualized advertising system is described in regard to FIG. 4.

FIG. 4 is a diagram of a system 400 configured to implement CTV OOH contextualized advertising, in accordance with certain embodiments of the present disclosure. In particular, FIG. 4 depicts a computer system 402, which may be an example of any computing system that may be employed to perform the operations of streaming service 102, user device 104, streaming device 106, ad server 110, and related processes and methods. Computing system 402 may include a processing system 404, a communication interface 406, and a user interface 408. Computing system 402 may include other components, such as a battery and enclosure, that are not shown for clarity. Computing system 402 may comprise one or more server computing systems, desktop computing systems, laptop computing systems, smartphone devices, set-top or streaming boxes, connected televisions, or any other computing system, including combinations thereof.

Communication interface 406 may comprise components that communicate over communication links, such as network cards, ports, radio frequency (RF), processing circuitry and software, or other communication components. Communication interface 406 may be configured to communicate over metallic, wireless, or optical links. Communication interface 406 may be configured to use Time Division Multiplex (TDM), Internet Protocol (IP), Ethernet, optical networking, wireless protocols, communication signaling, other communication formats, or any combinations thereof. Communication interface 406 may also enable communication with local external devices, such as external storage or interface devices.

User interface 408 may comprise components that interact with a user to receive user inputs and to present media or other information. User interface 408 may include a display screen, touch screen, touch pad, keyboard, buttons, speaker, microphone, pointer device or interface, communication port, other user input/output apparatus, or any combination thereof. User interface 408 may also include a camera or image capture apparatus for scanning elements such as QR codes. In some examples, user interface 408 may be a module configured to interface with a separate system for presenting information and receiving inputs. For example, computing system 402 may have limited or no direct user input components, but it connects (e.g., via communication interface 406) to a monitor or other device that may receive inputs via touch screen, remote control, or other input method, which inputs are then provided or relayed to computing system 402.

Processing system 404 may be linked to communication interface 406 and user interface 408. Processing system 404 can include processing circuitry 410 and memory device 412. Memory device 412 can store executable instructions or other operating software 416, as well as non-executable data files, such as user data 414, and stream content 422. User data 414 may include user data profiles, including user device MAID, location history, demographic and interests information (either affirmatively specified by a user or inferred from available information), advertising bid values submitted for the associated MAID, or other information. User data 414 may also include details about user profiles and accounts, billing information, transaction histories, preferences and settings, or other user-specific details. Stream content 422 may include video segments or combined streamable files, advertising files, details about different streams or channels, content and advertising schedules, access or routing details for content providers for streaming content, or other information associated with streaming content.

Processing circuitry 410 may comprise a microprocessor and other circuitry that can retrieve and execute instructions 416 from memory device 412. Memory device 412 may comprise a non-volatile data storage medium, such as a disk drive or solid state drive, or volatile memory such as random access memories (RAM) and dynamic RAM (DRAM), or any other memory apparatus. In some examples, processing circuitry 410 may be mounted on a circuit board that may also hold memory device 412 and portions of communication interface 406 or user interface 408.

Executable instructions 416 may comprise computer programs, firmware, or some other form of machine-readable processing instructions. Executable instructions 416 may include streaming app module 418, and CTV OOH advertising module 420, although related operations may be handled by multiple different modules or programs (potentially located on multiple computing devices), all operations may be performed by a single module, or additional modules may be included in executable instructions 416. For example, elements or aspects of streaming app module 418 and CTV OOH advertising module 420 may be implemented by streaming service 102, user device 104, streaming device 106, ad server 110, other systems, or a combination thereof. Executable instructions 416 may further include an operating system, utilities, drivers, network interfaces, applications, or other types of software. When executed by processing circuitry 410, executable instructions 416 may direct processing system 404 to operate computing system 402 as described herein.

Streaming app module 418 may be a set of instructions for communication between a user device and a streaming service, or a streaming service and a streaming device. For example, implemented at a user device, a streaming app module 418 may provide a graphical user interface (GUI) and manage data traffic with a streaming service, allowing a user to participate in games (e.g., trivia games displayed at venues via the streaming service), upload user content, interact with streamed content, check in at venues, select data sharing preferences, scan actionable content (e.g., QR codes) at streaming devices, or otherwise interact with a streaming service. The streaming app module 418 may share location data and user device MAID data with a streaming service, as described herein. Implemented at a streaming service, the streaming app module 418 may host a web app portal or website by which users can interact with the streaming service and share location information, or may interact with a streaming app module 418 executed at a user device. A streaming app module 418 executed at a streaming service may also interact with streaming devices at various venues, including sending them stream content 422, stream schedules, provide various streaming channels, send advertising information or files, generate and send custom actionable content for display at a venue (e.g., a custom QR code that specifically includes metadata identifying the venue or location at which the QR code is displayed), or otherwise provide content to the streaming devices. Implemented at a streaming device, the streaming app module 418 may be configured to receive streaming files, advertising files or information, streaming and advertising schedules, ticker or other data to superimpose or display with streamed content, or other information. Other implementations and functions may be performed via streaming app module 418, depending on the device and system arrangement.

CTV OOH advertising module 420 may include a set of computer functions or instructions for negotiating OOH advertisements between a streaming service and one or more ad providers based on a MAID associated with a user device at a particular venue. The CTV OOH advertising module 420 may be configured to gather user device MAID and location information (e.g., through streaming app module 418, user data 414, or both), and select one or more user device MAIDs to use to negotiate advertisements for an available ad inventory. The CTV OOH advertising module 420 may select a user device MAID from a venue randomly, in a selected order (e.g., round robin), or based on some value, such as prior advertising bids for a particular MAID. The CTV OOH advertising module 420 may provide the selected user device MAID, and potentially other data about an associated user from user data 414, to one or more advertisers or advertising exchange or SSP servers, to receive bids. The CTV OOH advertising module 420 may receive an indication of the winning bid, and may update a user data 414 entry for the selected user device MAID based on the bid. The CTV OOH advertising module 420 may then retrieve the winning ad, or otherwise arrange for the advertisement to be displayed at the selected location or venue, and may report back any playback verification or user interactions with the ad to the winning advertiser. Similarly, a streaming device may use CTV OOH advertising module 420 to access web addresses received from a streaming service in order to retrieve advertising files from an ad server, display them at the streaming device, report playback verification, or otherwise perform at-venue advertising operations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

1. A method comprising:
implementing a system to negotiate out-of-home (OOH) advertising based on a proximate user device, including:
receiving, at a content streaming service, an identifier of a user device and location information indicating a location of the user device, the user device including a portable computing device;
identifying an OOH advertising screen proximate to the location of the user device;
negotiating, via the content streaming service, an advertisement to display at the OOH advertising screen based on the identifier; and
displaying the advertisement at the OOH advertising screen.

2. The method of claim 1 further comprising:
the identifier includes a mobile advertising identifier (MAID) for the user device.

3. The method of claim 2 further comprising:
maintaining, at the content streaming service, a user data profile for the user device including the identifier.

4. The method of claim 3 further comprising:
negotiating the advertisement includes providing the identifier to an advertisement bidding platform; and
receiving, at the content streaming service, a winning advertisement bid based on the identifier.

5. The method of claim 4 further comprising:
updating the user data profile with a bid value based on the winning advertisement bid.

6. The method of claim 5 further comprising:
receiving, at the content streaming service, a plurality of identifiers corresponding to a plurality of user devices proximate to the OOH advertising screen; and
selecting a first identifier from the plurality of identifiers for negotiating the advertisement.

7. The method of claim 6 further comprising:
selecting the first identifier based on the bid value, from a prior winning advertisement bid, in the user data profile for a corresponding user device.

8. The method of claim 7 further comprising:
receiving the location information as global positioning system (GPS) data.

9. The method of claim 7 further comprising:
receiving the location information via the user device interacting with actionable content displayed at the OOH advertising screen.

10. A system comprising:
a content streaming service configured to negotiate out-of-home (OOH) advertising based on a user device proximate to an OOH advertising screen, including:
receive an identifier of the user device and location information indicating a location of the user device, the user device including a portable computing device;
negotiate an advertisement to display at an OOH advertising screen proximate to the location of the user device based on providing the identifier to an advertisement bidding platform; and
display the advertisement at the OOH advertising screen.

11. The system of claim 10, further comprising:
the identifier includes a mobile advertising identifier (MAID) for the user device.

12. The system of claim 10 further configured to:
receive a winning advertisement bid based on the identifier.

13. The system of claim 12 further configured to:
maintain a user data profile for the user device including the identifier;
update a bid value history for the user data profile based on the winning advertisement bid; and
select a first identifier for negotiating the advertisement, from a plurality of identifiers corresponding to a plurality of user devices proximate to the OOH advertising screen, based on the bid value history in the user data profile.

14. The system of claim 10 further configured to:
receive the location information as global positioning system (GPS) data.

15. The system of claim 10 further configured to:
generate custom actionable content corresponding to the OOH advertising screen;
display the custom actionable content at the OOH advertising screen; and
receive the location information via the user device interacting with the custom actionable content.

16. A memory device storing instructions that, when executed, cause a processor to perform a method comprising:
implementing, via a content streaming service, a system to negotiate out-of-home (OOH) advertising based on a proximate user device, including:
receiving a mobile advertising identifier (MAID) of a user device, the user device including a portable computing device;
receiving location information indicating a location of the user device, including:
generating custom actionable content corresponding to an OOH advertising screen to enable identification of a location of a user that interacts with the custom actionable content;
displaying the custom actionable content at the OOH advertising screen; and
receiving the location information via the user device interacting with the custom actionable content;
negotiating an advertisement to display at the OOH advertising screen based on the MAID; and
displaying the advertisement at the OOH advertising screen.

17. The memory device of claim 16 storing instructions that, when executed, cause the processor to perform the method further comprising:
negotiating the advertisement by providing the MAID to an advertisement bidding platform; and
receiving a winning advertisement bid based on the MAID.

18. The memory device of claim 17 storing instructions that, when executed, cause the processor to perform the method further comprising:
maintaining a user data profile for the user device including the MAID;
updating a bid value history for the user data profile based on the winning advertisement bid; and
selecting a first MAID for negotiating the advertisement, from a plurality of MAIDs corresponding to a plurality of user devices proximate to the OOH advertising screen, based on the bid value history in the user data profile.

19. The memory device of claim 16 storing instructions that, when executed, cause the processor to perform the method further comprising:
receiving the location information as global positioning system (GPS) data.

20. (canceled)

21. The memory device of claim 16 storing instructions that, when executed, cause the processor to perform the method further comprising:
identifying the OOH advertising screen proximate to the location of the user device.
